(19) United States
(12) Patent Application Publication
(10) Pub. No.: US 2017/0094467 A1
(43) Pub. Date: Mar. 30, 2017

(54) DIRECTION INDICATING DEVICE, WEARABLE DEVICE, VEHICLE, WIRELESS TERMINAL, AND COMMUNICATION SYSTEM

(71) Applicant: FUJITSU LIMITED, Kawasaki-shi (JP)

(72) Inventors: Keisuke KIUCHI, Kawasaki (JP); Hiroyuki Kawahara, Kawasaki (JP); Tatsuhiro SATO, Yokohama (JP); Ryo Tsumura, Numazu (JP); Masahiro Tsukahara, Yokohama (JP); Atsuji SEKIGUCHI, Kawasaki (JP); Yoshinobu Iwasato, Kawasaki (JP)

(73) Assignee: FUJITSU LIMITED, Kawasaki-shi (JP)

(21) Appl. No.: 15/254,155

(22) Filed: Sep. 1, 2016

(30) Foreign Application Priority Data
Sep. 29, 2015 (JP) 2015-191808

(51) Int. Cl. H04W 4/02; H04M 1/725; F21V 14/02

(52) U.S. Cl. CPC H04W 4/023; F21V 14/02; H04M 1/72527; F21W 2111/10

(57) ABSTRACT

A direction indicating device according to an embodiment includes: an orientation sensor that detects an orientation; a wireless communication device that receives orientation information; and a light emitting device. Furthermore, the direction indicating device includes a processor that controls the direction of light, generated by the light emitting device, in accordance with the angle that is formed by the detected orientation and the direction that is indicated by the received orientation information.

### CROSS-REFERENCE TO RELATED APPLICATION(S)

This application is based upon and claims the benefit of priority of the prior Japanese Patent Application No. 2015-191508, filed on Sep. 29, 2015, the entire contents of which are incorporated herein by reference.

### FIELD

The embodiment discussed herein is related to a direction indicating device, wearable device, vehicle, wireless terminal, and communication system.

### BACKGROUND

There are conventional terminal devices that acquire the present location by using the Global Positioning System (GPS), or the like, and that displays, on a screen, the guidance of the route to the previously set destination. Some of the terminal devices are portable ones, such as smartphone, which are held by the user's hand while in use, so that the user can more to the destination while checking the route guidance that is displayed on the terminal device.

Japanese Laid-open Patent Publication No 2009-265015

However, the above-described conventional technology has a problem in that there is a need to give a look at the terminal device to check the route guidance and it is difficult to check the circumstances while checking the route guidance. For example, if the user walks to the destination and checks the route guidance along the way, the user stops once and then checks the route guidance, displayed on the terminal device, as it is difficult for the user to sufficiently check the circumstances while giving a look at the terminal device. Then, after checking the route guidance, the user starts again to travel to the destination while checking the circumstances.

### SUMMARY

According to an aspect of an embodiment, a direction indicating device includes: an orientation sensor that detects an orientation; a wireless communication device that receives orientation information; a light emitting device; and a processor that controls a direction of light, generated by the light emitting device, in accordance with an angle that is formed by the orientation detected and a direction that is indicated by the orientation information received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram that illustrates an example of the configuration of a system according to an embodiment;

FIG. 2 is a block diagram that illustrates an example of the internal configuration of a direction indicating device according to the embodiment;

FIG. 3 is a ladder chart that illustrates an example of the operation of the system according to the embodiment;

FIG. 4 is an explanatory diagram that illustrates the setting screen for the destination;

FIG. 5 is an explanatory diagram that illustrates an example of the setting screen for the emergency evacuation area;

FIG. 6 is a flowchart that illustrates an example the emission operation;

FIG. 7 is an explanatory diagram that illustrates guidance by the direction indicating device according to the embodiment;

FIG. 8 is an explanatory diagram that illustrates a case where a direction indicating device according to the embodiment is installed in a vehicle;

FIG. 9 is an explanatory diagram that illustrates a case where a direction indicating device according to the embodiment is installed in a vehicle;

FIG. 10 is a ladder chart that illustrates a modified example of the operation of the system according to the embodiment; and

FIG. 11 is an explanatory diagram then illustrates the setting screen for another person.

### DESCRIPTION OF EMBODIMENT

Preferred embodiments of the present invention will be explained with reference to accompanying drawings. In the embodiment, the same reference numerals are applied to the components that have the same functionality, and duplicated explanations are omitted. Furthermore, the direction indicating device, wearable device, vehicle, wireless terminal, and communication system, explained in the following embodiment, are illustrated as only examples, and the embodiment is not limited to them. Furthermore, the following embodiment may be appropriately combined within the range that there are no contradictions.

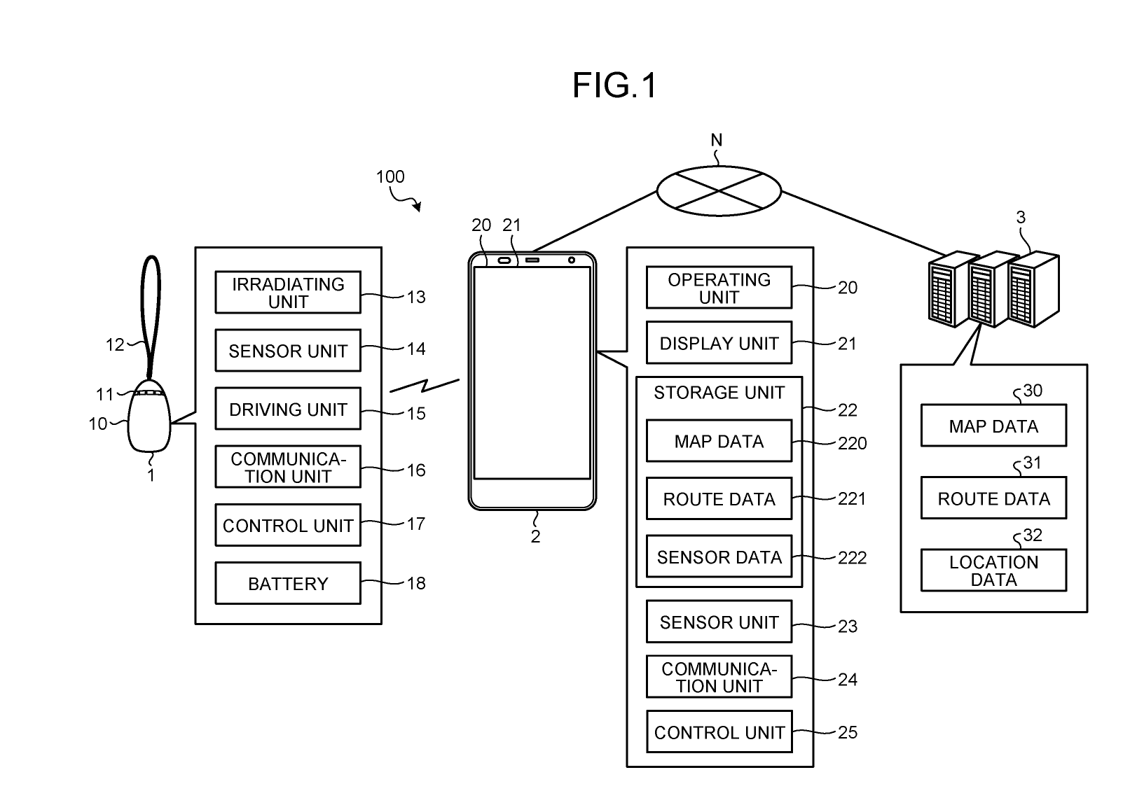

FIG. 1 is a block diagram that illustrates an example of the configuration of a system 100 according to the embodiment. As illustrated in FIG. 1, the system 100 includes a direction indicating device 1, a terminal device 2, and a server device 3.

The direction indicating device 1 is a device that emits laser light in a predetermined direction so as to indicate the direction to a user. The terminal device 2 is a wireless terminal, such as smartphone. The direction indicating device 1 and the terminal device 2 conduct data communication with each other via a wireless communication, such as the Bluetooth (registered trademark) Low Energy (BTLE) standard. Furthermore, the terminal device 2 connects to a network N, such as the Internet, via a mobile phone line, provided by a telecommunications carrier, or a wireless LAN.

The server device 3 provides a terminal with the route guidance service for providing the route information from the present location to the destination, the delivery service for urgent announcement e-mails during natural disasters, or the like, and various services, such as social networking service (SNS). The terminal device 2 is connected to the server device 3 via the network N so that it may use various services, provided by the server device 3.

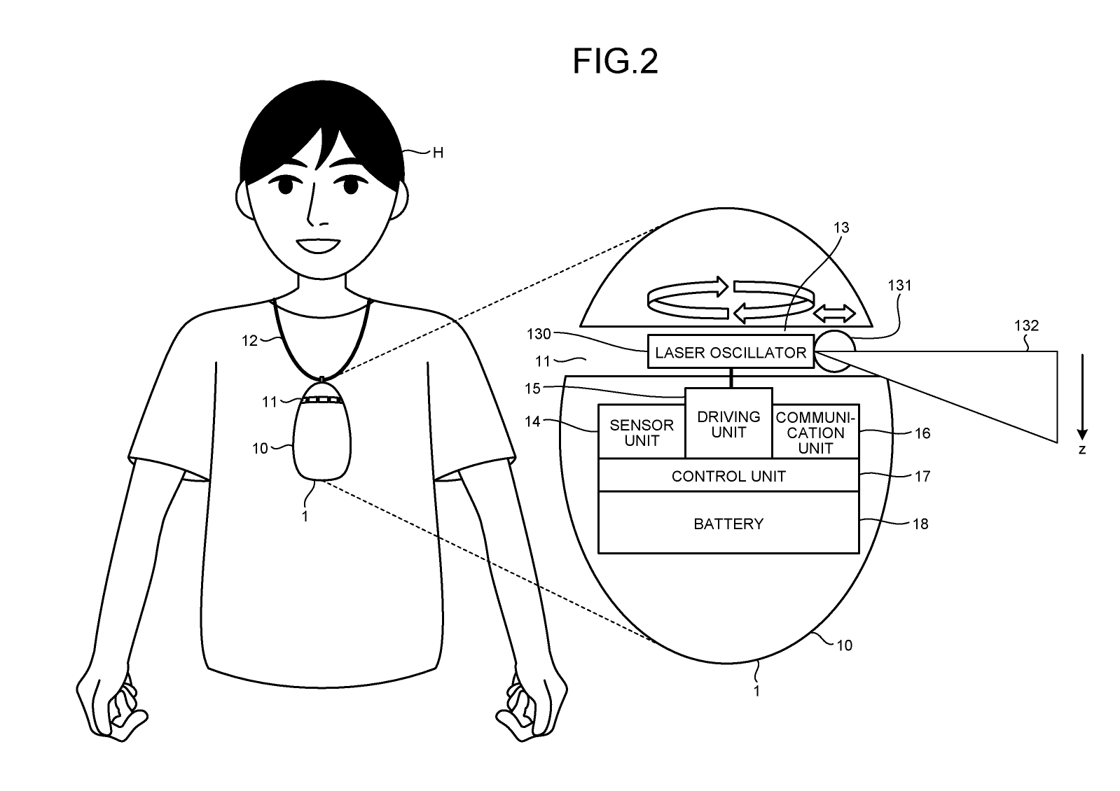

FIG. 2 is a block diagram that illustrates an example of the internal configuration of the direction indicating device 1 according to the embodiment. A illustrated in FIG. 2, the direction indicating device 1 is housed in a chassis 10 that is provided with a slit 11, through which laser light may be emitted to the outer periphery (360 degrees) of the direction indicating device 1, and a ring-shaped hanging tool 12, which is hung around a user H's hand, neck, or the like. Thus, the direction indicating device 1 is a wearable device that may be used while the user H wears it around the hand, neck, or the like (in the illustrated example, it is hung around the user H's neck).

The slit 11 is provided on the outer circumference of the chassis 10 such that it is open by 360 degrees at right angles to a hanging direction (vertical direction Z) while the chassis 10 is hung by the hanging tool 12. Thus, while the chassis 10 is hung, the direction indicating device 1 allows the laser light to emit from inside through the slit 11 in any direction to the north, south, east, and west by 360 degrees.

Inside the chassis 10, the direction indicating device 1 includes an irradiating unit 13, a sensor unit 14, a driving unit 15, a communication unit 16, a control unit 17, and a battery 18.

The irradiating unit 13 includes a laser oscillator 130 and a diffusing lens 131. The laser oscillator 130 is a laser diode (LD), or the like, which emits light in red, green, or the like, and it emits laser light 132. The laser oscillator 130 may be provided with multiple LDs to emit the laser light 132 with different colors, such as red or green, in the same direction.

The diffusing lens 131 is an optical lens that diffuses the laser light 132, emitted by the laser oscillator 130. Specifically, the diffusing lens 131 diffuses the laser light 132 from the laser oscillator 130 at a predetermined angle such that it tilts downward (Z direction). Thus, the laser light 132, emitted as a point by the laser oscillator 130, is linearly emitted in the Z direction. For example, if the direction indicating device 1 is hung around the user H's neck while in use, the laser light 132 from the direction indicating device 1 draws a straight line on the ground in front of the user H as it is tilted in the Z direction.

Here, the angle, at which the diffusing lens 131 diffuses the laser light 132, i.e., the length of the straight line that is drawn on the ground, is adjustable by using, for example, the distance between the laser oscillator 130 and the diffusing lens 131. For example, by decreasing the distance between the laser oscillator 130 and the diffusing lens 131, the angle for diffusion may be larger (the straight line, drawn on the ground, may be longer). Conversely, by increasing the distance, the angle for diffusion may be smaller (the straight line, drawn on the ground, may be shorter).

Furthermore, the laser oscillator 130 and the diffusing lens 131 are supported by a supporting member (not illustrated) inside the chassis 10. The supporting member is configured to support the laser oscillator 130 and the diffusing lens 131 on the turntable that is rotatable by 360 degrees at the rotation axis in the Z direction, for example. Moreover, the supporting member has a slide mechanism that adjusts the distance between the laser oscillator 130 and the diffusing lens 131.

With regard to the supporting member and the slide mechanism for the laser oscillator 130 and the diffusing lens 131, the rotation direction and the degree of slide are adjusted by using the driving force of a motor of the driving unit 15, or the like. Therefore, the irradiation direction of the laser light 132 from the laser oscillator 130 is adjusted due to driving of the driving unit 15.

The sensor unit 14 is various sensors, including an orientation sensor that determines the direction (orientation) of the direction indicating device 1 by measuring the earth magnetism. As for the sensor unit 14, examples of the various sensors other than the orientation sensor, which detects the direction of the direction indicating device 1, include an irradiance sensor that measures the irradiance around the direction indicating device 1 or an acceleration sensor (gyro) that measures the acceleration value in the directions of the X, Y, and Z axes (three axes). A detection value from a sensor in the sensor unit 14 is output to the control unit 17.

The driving unit 15 drives the irradiating unit 13 tinder the control of the control unit 17. Specifically, the driving unit 15 feeds voltage and current to the laser oscillator 130 so as to drive the laser oscillator 130 and emit the laser light 132. Furthermore, the driving unit 15 may control the amount of voltage and current, which are fed to the laser oscillator 130, to adjust the irradiance of the laser light 132. Moreover, the driving unit 15 may control the presence or absence of emissions of multiple LDs with different colors, such as red or green, so as to control the color of the laser light 132.

Furthermore, under the control of the control unit 17, the driving unit 15 drives the motor for applying the driving force to the supporting member and the slide mechanism in the laser oscillator 130, thereby adjusting the irradiation direction of the laser oscillator 130. Specifically, the driving unit 15 adjusts the degree of rotation of the above-described turntable to adjust the irradiation direction of the laser oscillator 130 around the shaft with the Z direction as the rotation axis. Furthermore, the driving unit 15 adjusts the distance between the laser oscillator 130 and the diffusing lens 131 with the above-described slide mechanism, thereby adjusting the angle at which the laser light 132 is diffused.

The communication unit 16 is a transmitting/receiving circuit, an antenna, or the like, for wireless communication, and it performs wireless communication under the control of the control unit 17. For example, the communication unit 16 performs wireless communication by using a communication standard, such as BTLE, thereby transmitting and receiving data to and from the terminal device 2.

The control unit 17 is for example a micro-processing unit (MPU), and it controls the overall operation of the direction indicating device 1. For example, the control unit 17 receives notification of the emission command information for emission of the laser light 132 from the terminal device 2 via the wireless communication of the communication unit 16. Then, the control unit 17 controls the driving unit 15 on the basis of the notified emission command information so as to emit the laser light 132 from the laser oscillator 130.

For the emission of the laser light 132, the control unit 17 controls the irradiation direction (emission direction) of the laser light 132 around the shaft with the Z direction as the rotation axis in accordance with the angle that is formed by the direction (orientation) of the direction indicating device 1, measured by the sensor unit 14, and the direction for emission, indicated by the emission command information.

Specifically, on the basis of the direction (orientation) of the direction indicating device 1 and the current irradiation direction of the laser light 132, adjusted by the driving unit 15, the control unit 17 obtains the degree of rotation around the shaft in the direction such that the irradiation direction of the laser light 132 faces the direction for emission, indicated by the emission command information. Then, the control unit 17 drives the driving unit 15 by the obtained degree of rotation to rotate the irradiation direction of the laser light 132, thereby emitting the laser light 132 in the direction for emission, indicated by the emission command information.

The battery 18 is a power source that feeds the electric power to the entire direction indicating device 1, and it is, for example, a primary battery or a secondary battery.

With reference back to FIG. 1, the terminal device 2 includes an operating unit 20, a display unit 21, a storage unit 22, a sensor unit 23, a communication unit 24, and a control unit 25.

The operating unit 20 is, for example, a touch panel that is provided on the display unit 21, and it receives an operation of the user H of the terminal device 2. The display unit 21 is, for example, a liquid crystal display, and it displays various types of information.

The storage unit 22 is a storage device that stores various programs and data that is used for the various programs, such as map data 220, route data 221, or sensor data 222, as well as the operating system (OS) that is executed by the control unit 25. For example, various semiconductor memory devices, such as a random access memory (RAM) or a flash memory, may be used as the storage unit 22. Furthermore, a hard disk drive (HDD), a solid state drive (SSD), or the like, may be used as the storage unit 22.

The map data 220 is the map information that is used for map drawing, route calculation, or the like. Examples of the map data 220 include a point of interest (POI), such as data on the major facilities, road data (the route and the distance of each road, the width of a road, a traffic regulation speed, or the like), the identification information on a traffic intersection, or geographical name data.

The route data 221 is the data on the route to the destination, obtained during the route calculation. For example, the route data 221 includes the information on the location and the distance of a direction change point, which is linked to the map information in the map data 220 with regard to the route to the destination.

The sensor data 222 is the information on the detection value that is detected by the sensor unit 23. For example, the sensor data 222 includes the values that indicate the present location of the terminal device 2, detected by the sensor unit 23, the attitude of the terminal device 2 in the directions of the X, Y, and Z axes (three axes), or the like.

The sensor unit 23 is various sensors including a global positioning system (GPS) sensor that measures the present location, such as the latitude and the longitude, of the terminal device 2. Examples of the various sensors other than the GPS sensor, which measures the location of the terminal device 2, include an orientation sensor that determines the direction (orientation) of the terminal device 2 by measuring the earth magnetism or an acceleration sensor that detects the attitude of the terminal device 2 by using the acceleration value in the directions of the X, Y, and Z axes (three axes). The detection value, detected by a sensor in the sensor unit 23, is stored in the sensor data 222.

The communication unit 24 is a transmitting/receiving circuit, an antenna, or the like, for wireless communication, and it performs wireless communication under the control of the control unit 25. Specifically, the communication unit 24 performs wireless communication by using communication standard, such as BTLE, thereby transmitting and receiving data to and from the direction indicating device 1. Furthermore, the communication unit 24 performs a communication connection with the network N due to the wireless communication via a mobile phone line, provided by a telecommunications carrier, a wireless LAN, or the like.

The control unit 25 is a central processing unit (CPU), or the like, and controls the overall operation of the terminal device 2 when the CPU executes a program.

For example, the control unit 25 performs an operation to display, on the display unit 21, the setting screen for setting the information, indicating the destination, receive an operation from the operating unit 20, and set the destination. Then, the control unit 25 performs an operation to acquire the route data 221 on the present location of the terminal device 2, acquired from the sensor unit 23, to the set destination.

Specifically, the control unit 25 notifies the server device 3 of the set destination and the present location of the terminal device 2 via the communication unit 24. Then, the control unit 25 acquires a result (route data 31) of the route calculation performed by the server device 3 and stores it as the route data 221 in the storage unit 22. Here, in the case illustrate according to the present embodiment, the route data 221 is acquired from the server device 3; however, for the route data 221, the control unit 25 may conduct route calculation by referring to the map data 220 on the basis of the set destination and the present location of the terminal device 2.

Furthermore, the control unit 25 performs an operation to calculate the distance to the destination, the direction (orientation), or the like, on the basis of the present location of the terminal device 2, acquired from the sensor unit 23, the route data 221, and the map data 220. The distance and the direction to the destination may be the linear distance and the direction, which linearly connects to the destination from the present location of the terminal device 2, or they may be the distance (way) and the direction from the present location of the terminal device 2 along the route that is indicated by the route data 221.

Furthermore, the control unit 25 generates the emission command information for causing the direction indicating device 1 to emit the laser light 132 in accordance with the calculated distance and direction to the destination, and it notifies the direction indicating device 1 of the generated emission command information via the communication unit 24. Specifically, the control unit 25 generates the emission command information for setting the calculated direction (the direction that linearly connects to the destination or the direction from the present location along the route) as the irradiation direction (orientation) and notifies it to the direction indicating device 1. Furthermore, the control unit 25 generates the emission command information for setting the irradiation range, the irradiance, or the light emission color in accordance with the distance to the destination and notifies it to the direction indicating device 1.

The server device 3 is a computer that provides various services, including the route guidance service that provides the route information on the present location to the destination. The server device 3 may be implemented by installing programs for executing various services as package software or online software in a desired computer. Furthermore, the server device 3 may be implemented as a cloud for providing various services through outsourcing.

The server device 3 has map data 30, the route data 31, and location data 32 as data for the route guidance service.

The map data 30 is the map information that is used for the route calculation, or the like, as is the case with the map data 220. The route data 31 is the data on the route to the destination, obtained during the route calculation, as is the case with the route data 221. Furthermore, according to the present embodiment, the route data 31 from the route calculation of the server device 3 is transmitted to the terminal device 2 via the network N and is stored as the route data 221 in the storage unit 22. The location data 32 is the data that manages the positional information on the terminal device 2, notified by the terminal device 2, together with the terminal identification data (ID) for identifying the terminal device 2, or the like. The server device 3 updates the location data 32 on the basis of the positional information, notified by the terminal device 2, and the terminal ID, and it manages the present location of each of the terminal devices 2.

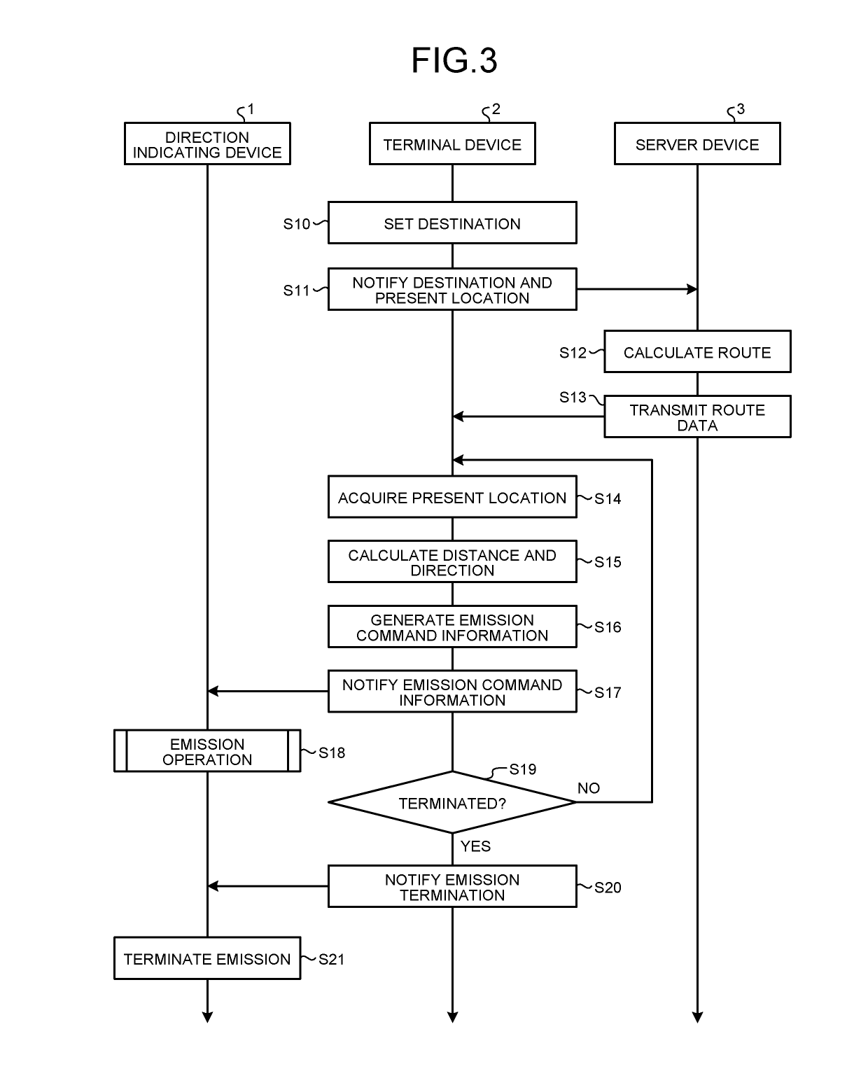

FIG. 3 is a ladder chart that illustrates an example of the operation of the system 100 according to the embodiment.

As illustrated in FIG. 3, under the control of the control unit 25, the terminal device 2 conducts destination settings by displaying, on the display unit 21, the setting screen for setting the information that indicates the destination, receiving an operation from the operating unit 20, and setting the destination (S10).

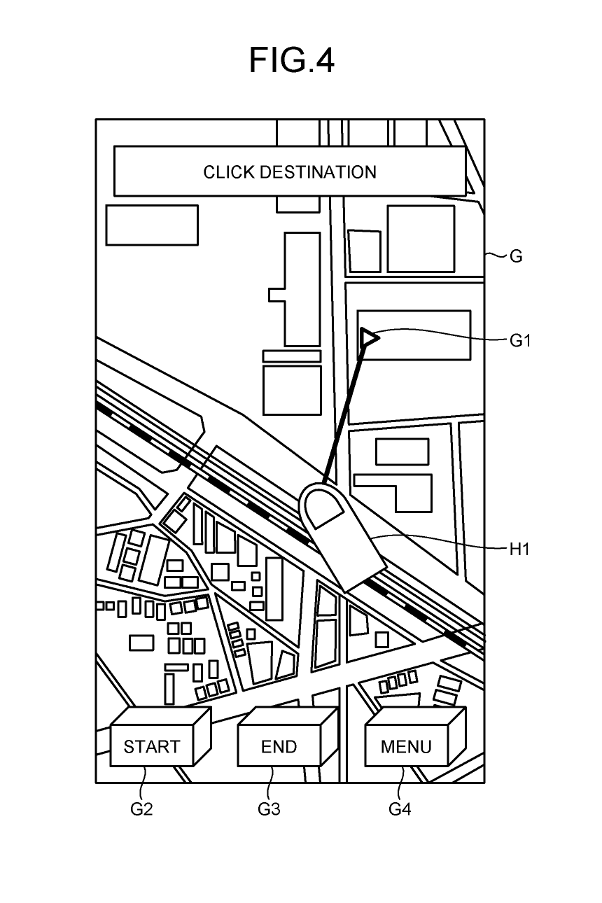

FIG. 4 is an explanatory diagram that illustrates the setting screen for the destination. As illustrated in FIG. 4, the terminal device 2 displays, on a display screen G of the display unit 21, the setting screen that presents the map that is referenced from the map data 220, or the like, and receives the destination set by the operating unit 20 at S10. Specifically, upon reception of an operation of a cursor G1 by a fingertip H1 of the user H and operations of operation buttons G2 to G4 that indicate various operations, such as “start”, “end”, or “menu”, the setting of the destination, indicated by the cursor G1 on the map, is received.

Here, the destination setting is not limited to the example of FIG. 4. For example, the destination setting may be conducted by selecting an area (e.g., an evacuation area that is notified by an urgent announcement e-mail), notified by the delivery service of the server device 3, or the like.

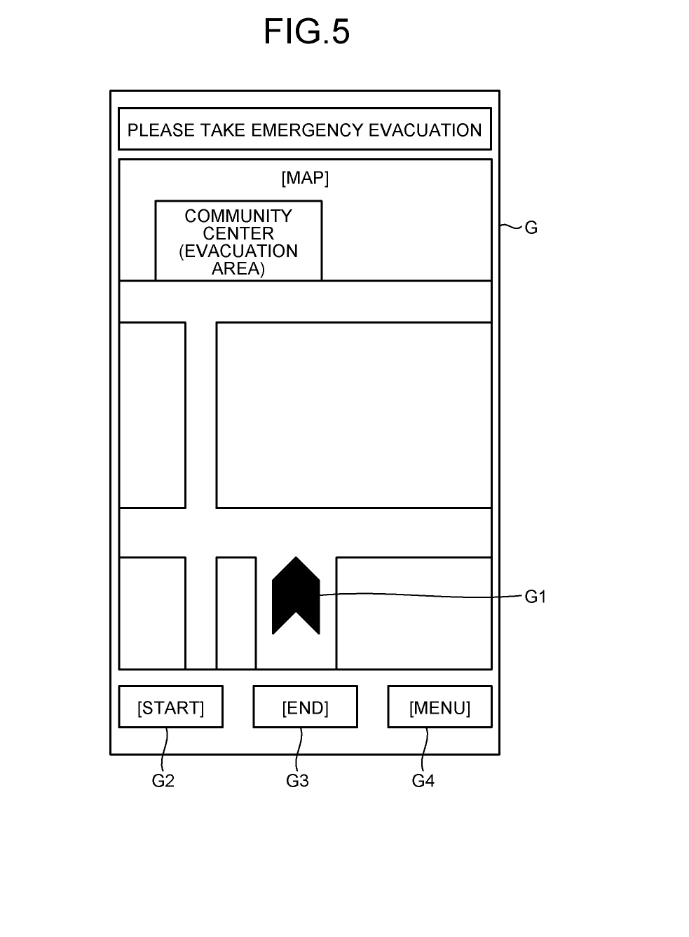

FIG. 5 is an explanatory diagram that illustrates an example of the setting screen for the emergency evacuation area. As illustrated in FIG. 5, at S10, the terminal device 2 may display, on the display screen G of the display unit 21, the setting screen for setting the evacuation area, noted by the server device 3 due to an urgent announcement e-mail, or the like, as the destination and may receive the destination set by the operating unit 20.

With reference back to FIG. 3, next to S10, the control unit 25 of the terminal device 2 notifies the server device 3 of the destination, which is set at S10, and the present location of the terminal device 2, which is detected by the sensor unit 23, via the communication unit 24 (S11).

On the basis of the destination, notified by the terminal device 2, and the present location of the terminal device 2, the server device 3 refers to the map data 30 to calculate the route from the present location of the terminal device 2 to the destination (S12). This route calculation is a calculation of the shortest route that conforms with various conditions (travel by foot, bicycle, or car, travel by a transportation facility, such as train or bus, a short travel time, a low travel cost, or the like), which are previously set by the user H, by using a known route search technique.

Next, the server device 3 notifies the terminal device 2 of the route data 31 that is obtained during the route calculation (S13). The control unit 25 of the terminal device 2 stores the route data 221 in the storage unit 22 in response to the notification from the server device 3. Thus, the terminal device 2 starts route guidance (S14 to S19) on the basis of the route data 221.

Specifically, the control unit 25 of the terminal device 2 acquires the present location of the terminal device 2 from the sensor unit 23 (S14). Next, the control unit 25 calculates the distance to the destination, the direction (orientation), or the like, on the basis of the present location of the terminal device 2, the route data 221, and the map data 220 (S15).

For example, the control unit 25 plots the present location of the terminal device 2 and the destination, included in the route data 221, on the map that is indicated by the map data 220, and calculates the linear distance and the direction to the destination. Furthermore, the control unit 25 plots the present location of the terminal device 2 and the route information (multiple direction change points and their distances) on the destination, included in the route data 221, on the map that is indicated by the map data 220, and it calculates the distance to the destination along the route. Moreover, the control unit 25 determines the line segment that connects the present location of the terminal device 2 and the next direction change point, or the like, to calculate the direction along the route.

Next, the control unit 25 generates the emission command information for causing the direction indicating device 1 to emit the laser light 132 in accordance with the calculated distance and direction to the destination (S16) and notifies the generated emission command information to the direction indicating device 1 via the communication unit 24 (S17).

Here, the notification of the emission command information may be made on the basis of the present location of the terminal device 2. For example, the control unit 25 refers to the map data 220 on the basis of the present location of the terminal device 2 and, if the present location of the terminal device 2 is included in a predetermined area, it may suppress the notification of the emission command information. For example, if the present location of the terminal device 2 is inside a predetermined building or inside a train (on the line of a train), the notification of the emission command information is suppressed. In this way, notification of the emission command information is suppressed in accordance with the present location of the terminal device 2; thus, for example, in the case that is not suitable for the route guidance (while inside a building, or during travel by train), the laser light 132 is prevented from being emitted.

After receiving the emission command information, notified by the terminal device 2, the direction indicating device 1 performs an emission operation to emit the laser light 132 on the basis of the emission command information (S18).

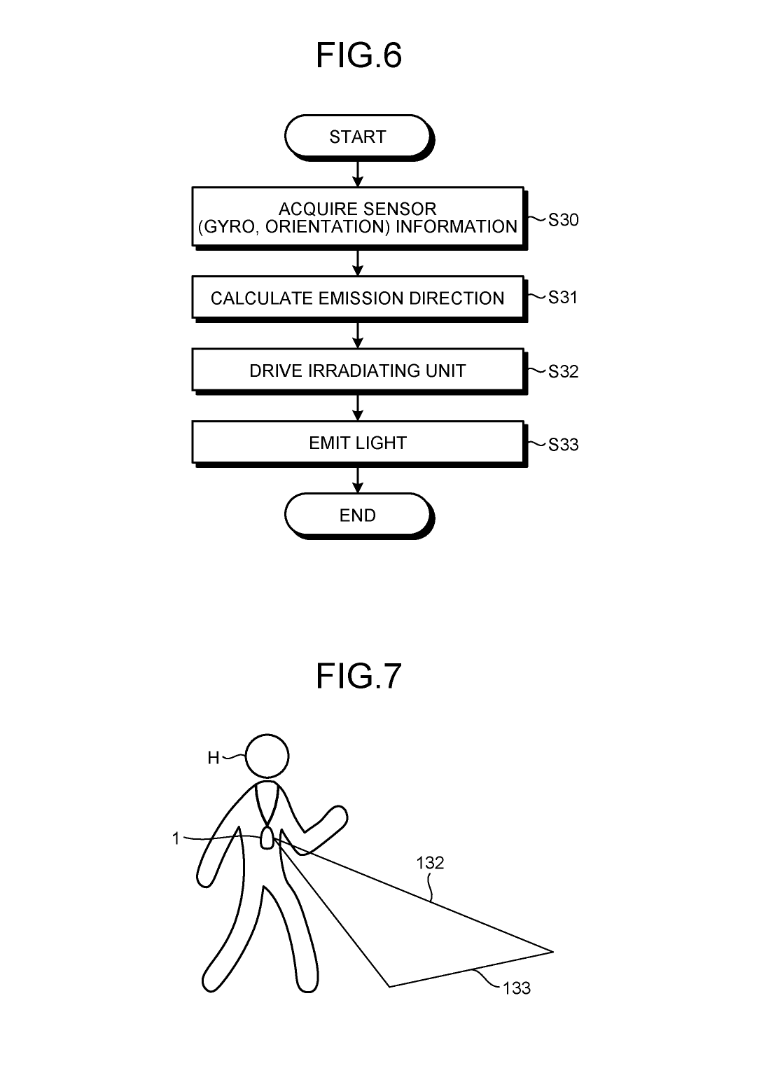

FIG. 6 is a flowchart that illustrates an example of the emission operation. As illustrated in FIG. 6, after the operation is started, the control unit 17 acquires sensor (gyro, orientation) information from the sensor unit 14 (S30).

Next, on the basis of the emission command information that is notified by the terminal device 2, the control unit 17 calculates the irradiation direction (emission direction) of the laser light 132 around the shaft with the Z direction as the rotation axis (S31). Specifically, the control unit 17 obtains the degree of rotation around the shaft in the Z direction on the basis of the direction (orientation) of the direction indicating device 1 such that the direction (the direction that linearly connects to the destination or the direction from the present location along the route), included in the emission command information, is the irradiation direction.

Next, due to the driving of the irradiating unit 13 by the driving unit 15 (S32), the control unit 17 faces the laser oscillator 130 in the irradiation direction that is calculated at S31. Furthermore, due to the driving of the irradiating unit 13 by the driving unit 15 (S32), the control unit 17 adjusts the distance between the laser oscillator 130 and the diffusing lens 131 so as to correspond to the irradiation range that is specified by the emission command information.

Next, the control unit 17 controls the driving unit 15 so as to emit the laser light 132 with the irradiance or the light emission color, specified by the emission command information, thereby conducting emission of the irradiating unit 13 (S33). During the above described emission operation, the direction indicating device 1 emits the laser light 132 onto the ground in front of the user H in accordance with the distance and the direction to the destination.

FIG. 7 is an explanatory diagram that illustrates guidance by the direction indicating device 1 according to the embodiment. As illustrated in FIG. 7 the direction indicating device 1 emits the laser light 132 onto the ground in accordance with the distance and the direction to the destination. Thus, an emission position 133 of the laser light 132 indicates, for example, the direction that linearly connects to the destination or the direction from the present location along the route.

Hence, the user H checks the emission position 133 on the ground while checking the circumstances without giving a look at the display unit 21 of the terminal device 2, thereby easily recognizing the direction to the destination.

Furthermore, the emission position 133 of the laser light 132 corresponds to the distance to the destination. For example, the irradiation range (the length of the straight line) corresponds to the distance value to the destination, i.e., it may be wider (the straight line may be longer) as the distance is longer. Furthermore, the irradiance may be higher as the distance to the destination is shorter. Moreover, the light emission color may be changed in any way, e.g., red if the distance value to the destination is equal to or more than a predetermined value, green if it is equal to or less than the predetermined value, and yellow if the distance value is 0 (arrives at the destination).

Hence, the user H checks the emission position 133 on the ground while checking the circumstances without giving a look at the display unit 21 of the terminal device 2, thereby easily recognizing the distance to the destination.

With reference back to FIG. 3, next to S17, the control unit 25 determines whether the route guidance is terminated (S19). Specifically, if the arrival at the destination is detected on the basis of the present location of the terminal device 2, or if the termination command from the operating unit 20 is detected, the control unit 25 determines that the route guidance is terminated (S19: YES).

If the route guidance is not terminated (S19: NO), the control unit 25 returns to the operation at S14 and continues the route guidance. If the route guidance is terminated (S19: YES), the control unit 25 notifies the emission termination to the direction indicating device 1 via the communication unit 24 (S20). After receiving the emission termination, notified by the terminal device 2, the direction indicating device 1 terminates the emission operation (S21).

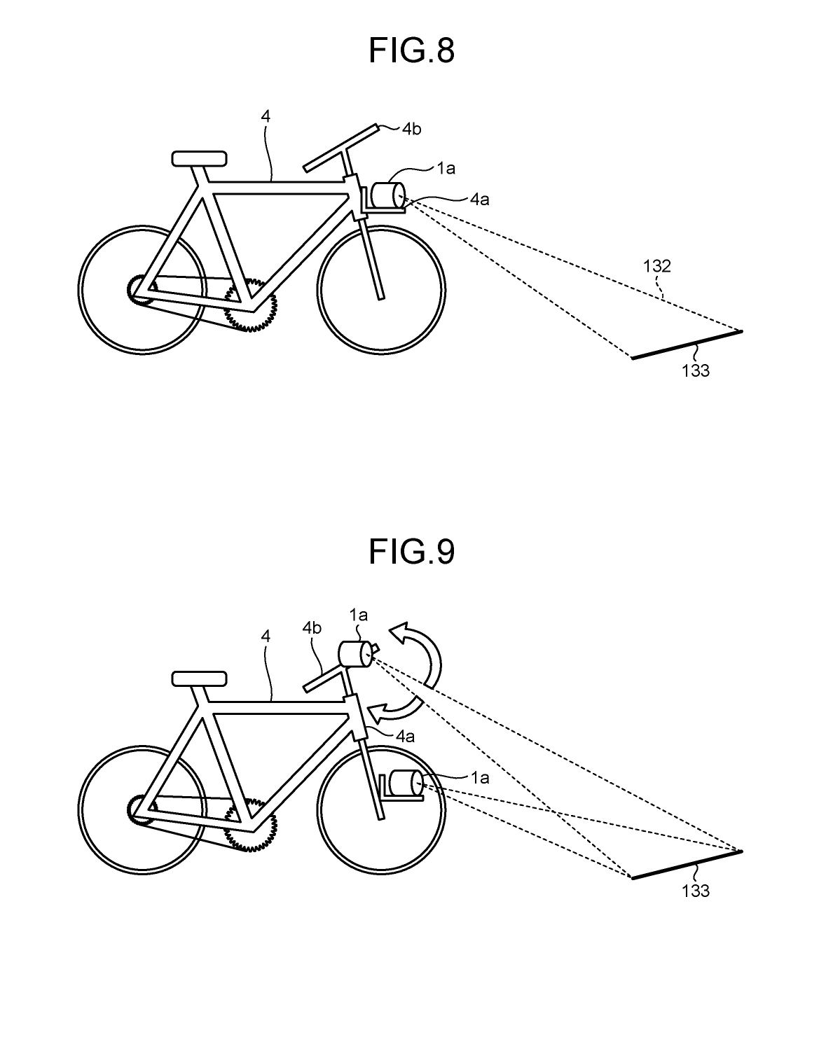

Furthermore, the direction indicating device 1 may be installed in a vehicle, such as a bicycle or a car, while in use. FIGS. 8 and 9 are explanatory diagrams that illustrate a case where a direction indicating device 1a according to the embodiment is installed in a vehicle 4. Here, the internal configuration of the direction indicating device 1a, illustrated in FIGS. 8 and 9, is substantially the same as that of the direction indicating device 1.

As illustrated in FIG. 8, the direction indicating device 1a may be installed on the front section of a frame 4a of the vehicle 4, which is a bicycle, while in use. In the case of the front section of the frame 4a, shaking due to an operation of handlebars 4b is hardly transmitted, and the emission position 133 of the laser light 132 is stable. Therefore, the emission position 133 is easily viewable. However, if a basket, or the like, is provided on the front section of the frame 4a, there is a possibility that the laser light 132 from the direction indicating device 1a is blocked by the basket, and therefore the installation layout is sometimes restricted.

As illustrated in FIG. 9, the direction indicating device 1a may be installed on the handlebars 4b of the vehicle 4, on the installation position of the light that operates simultaneously with the handlebars 4b, or the like, while in use. In this case, although the flexibility of the installation layout is increased, an effect of shaking due to an operation of the handlebars 4b easily occurs, and therefore the emission position 133 of the laser light 132 is unstable.

Here, the installation of the direction indicating device 1a on the vehicle 4 is not limited to the examples of FIGS. 8 and 9. For example, the type of the vehicle 4 may be a car instead of a bicycle. For example, if it is installed on a car, it may be provided on the dashboard of the car such that the laser light 132 is emitted to the instrument panel, or the like, or it may be hung from the roof.

### Modified Example

In the case that is illustrated according to the above-described embodiment, a predetermined point is set as the destination, and the route to the point is guided. However, not only a predetermined point but also the terminal device (another person's terminal) of the user (another person), who is different from the user H, may be specified as the destination.

The information (ID, address, or the like) for identifying the terminal device 2 is exchanged with each other by using, for example, a social networking service (SNS), and the another person's terminal is designated so that the target in set. In thin way, if the another person's terminal is set as the destination, the route is sequentially updated in accordance with the present location of each other's terminal device.

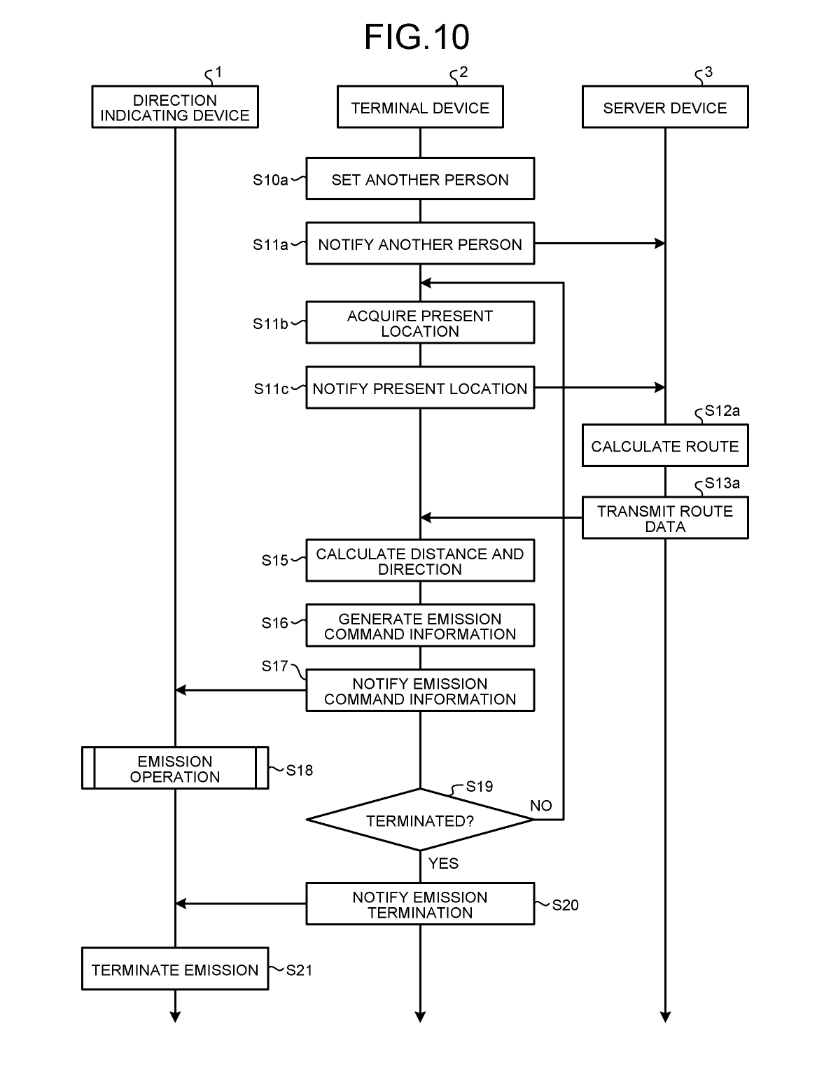

FIG. 10 is a ladder chart that illustrates a modified example of the operation of the system according to the embodiment. Here, it is assumed that each of the terminal devices 2 notifies the server device 3 of the positional information that is measured on a regular basis and the location data 32 in the server device 3 is updated on the basis of the notified positional information.

As illustrated in FIG. 10, the setting screen for setting the information for identifying the another person's terminal, which is a destination, is presented on the display unit 21, an operation is received from the operating unit 20, and another person is set as the destination (S10a).

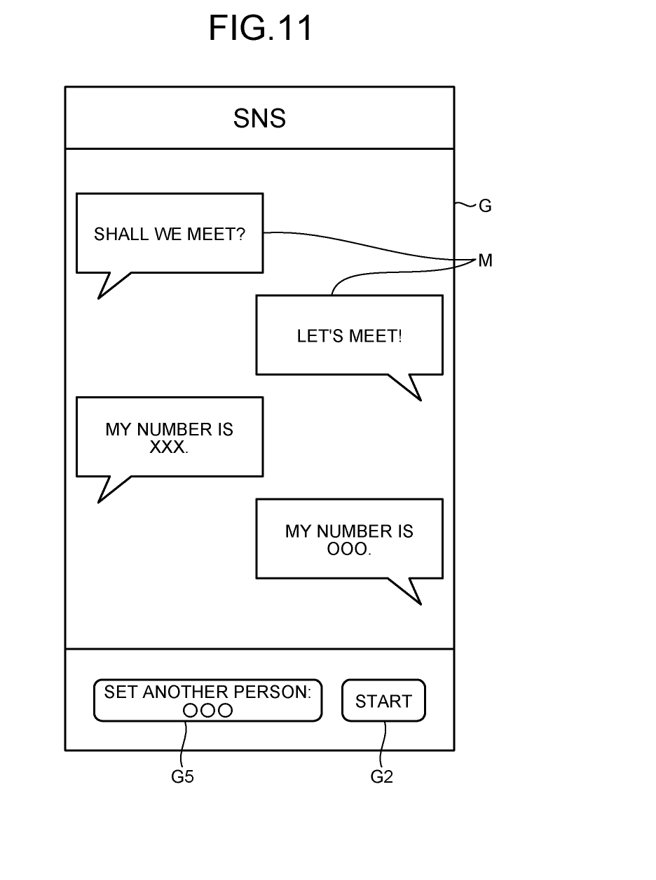

FIG. 11 is an explanatory diagram that illustrates the setting screen for another person. As illustrated in FIG. 11, at S10a, the terminal device 2 receives, on a setting area G5, the number (“OOO” in the illustrated example) for identifying the another person's terminal, obtained by a message M of the SNS, or the like. Thus, the terminal device 2 receives the setting of the another person's terminal as the destination.

With reference back to FIG. 10, next to S10a, the control unit 25 of the terminal device 2 notifies the information (e.g., the identification number of the another person's terminal) that indicates the another person's terminal, which is set at S10a, to the server device 3 via the communication unit 24 (S11a).

Next, the control unit 25 acquires the present location of the terminal device 2 from the sensor unit 23 (S11b) and notified the acquired precent location to the server device 3 via the communication unit 24 (S11c).

On the basis of the information on the another person's terminal, which is the destination, and the present location of the terminal device 2, the server device 3 calculates the route from the present location of the terminal device 2 to the another person's terminal (S12a). Specifically, the positional information on the another person's terminal is acquired from the location data 32, and the route from the present location of the terminal device 2 to the position of the another person's terminal is calculated.

Next, the server device 3 notifies the terminal device 2 of the route data 31 that is obtained during the route calculation (S13a). Afterward, the same operations as those described above are performed during the operations from S15 to S19 and, if the route guidance is not terminated (S19: NO), the control unit 25 returns to the operation at S11b.

Thus, an operation is continuously performed to sequentially update the route in accordance with the present location of each other's terminal device. As described above in the modified example, the system 100 is applicable to the route guidance where the another person's terminal is the destination.

Furthermore, components of each device illustrated do not always need to be physically configured as illustrated in the drawings. Specifically, specific forms of separation and combination of each device are not limited to those depicted in the drawings, and a configuration may be such that all or some of them are functionally or physically separated or combined in an arbitrary unit depending on various types of loads or usage.

For example, the direction indicating device 1 may be installed in the terminal device 2. Furthermore, a configuration may be such that an application program for route guidance is installed in the terminal device 2 and the control unit 25 conducts route calculations so that the terminal device 2 conducts route guidance by itself without using the server device 3.

According to an embodiment of the present invention, it is possible to easily check the circumstances while checking the route guidance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A direction indicating device comprising:
an orientation sensor that detects an orientation;
a wireless communication device that receives orientation information;
a light emitting device; and
a processor that controls a direction of light, generated by the light emitting device, in accordance with an angle that is formed by the orientation detected and a direction that is indicated by the orientation information received.

2. The direction indicating device according to claim 1, wherein the direction of the light is tilted downward.

3. The direction indicating device according to claim 1, wherein the processor controls at least one of a range within which the light, generated by the light emitting device, is emitted, irradiance of the light, and a light emission color in accordance with a signal that is received by the wireless communication device.

4. The direction indicating device according to claim 3, wherein the signal, received by the wireless communication device, is information that indicates a distance to a destination.

5. A wearable device comprising the direction indicating device according to claim 1.

6. A vehicle comprising the direction indicating device according to claim 1.

7. A wireless terminal comprising:
a location measuring unit;
a receiving unit that receives information that indicates a destination;
a calculating unit that calculates orientation information on a destination, indicated by the information received, relative to a location that is measured by the location measuring unit; and
a wireless communication unit that transmits the orientation information calculated to a direction indicating device, which controls an emission direction of a light emitting device, in accordance with calculation of the orientation information.

8. The wireless terminal according to claim 7, wherein the wireless communication unit transmits the orientation information in accordance with a location that is measured by the location measuring unit.

9. The wireless terminal according to claim 7, wherein
the receiving unit receives information that indicates another terminal that is a destination, and
the calculating unit calculates orientation information on the another terminal.

10. A communication system comprising:
a wireless terminal; and
a direction indicating device, wherein
the wireless terminal and the direction indicating device include
a location measuring unit;
a receiving unit that receives a designated destination;
a calculating unit that calculates orientation information on the designated destination relative to a location that is measured by the location measuring unit;
an orientation sensor that detects an orientation;
a light emitting device; and
a processor that controls a direction of light, generated by the light emitting device, in accordance with an angle that is formed by the orientation detected and a direction that is indicated by the orientation information calculated.
